(19) United States
(12) Patent Application Publication
(10) Pub. No.: US 2026/0227638 A1
(43) Pub. Date: Aug. 6, 2026

(54) SYSTEMS AND METHODS FOR IMAGE PROJECTION

(71) Applicant: Tape Art LLC, Providence, RI (US)

(72) Inventors: Michael Townsend, Providence, RI (US); Leah Smith, Providence, RI (US)

(73) Assignee: Tape Art LLC, Providence, RI (US)

(21) Appl. No.: 19/046,911

(22) Filed: Feb. 6, 2025

(51) Int. Cl. G02B 27/09; G03B 21/20

(52) U.S. Cl. CPC G02B 27/0955; G03B 21/2033

(57) ABSTRACT

A projector can include a housing, a light source, a first achromatic doublet, and a second achromatic doublet. The light source can provide a light beam and positioned at a first position within the housing. The first achromatic doublet can be positioned at a second position within the housing. The second achromatic doublet can be positioned at a third position within the housing. The second position can be between the first position and the third position. The housing can include a slot to receive a slide including a graphical image. The slot can receive the slide located between the first position and the second position and at a defined distance from the first achromatic doublet. The defined distance can be dependent on focal lengths of the first achromatic doublet and the second achromatic doublet and a distance between the first achromatic doublet and the second achromatic doublet.

### TECHNICAL FIELD

The present disclosure generally relates to image projections, including without limitations, systems, methods and devices for projection of images.

### BACKGROUND

Optical systems can combine various optical components to manipulate light for specific purposes, such as image focusing, magnification or projection. Optical systems can direct, bend, or split light to achieve desired visual outcomes in various applications, such as cameras, projectors, microscopes, and telescopes. Arrangement of components in an optical system can determine its performance, clarity, magnification, and distortion.

### SUMMARY OF THE INVENTION

According to at least one aspect, a projector can include a housing, a light source, a first achromatic doublet, and a second achromatic doublet. The light source can provide a light beam and positioned at a first position within the housing. The first achromatic doublet can be positioned at a second position within the housing. The second achromatic doublet can be positioned at a third position within the housing. The second position can be between the first position and the third position. The housing can include a slot to receive a slide including a graphical image. The slot can receive the slide located between the first position and the second position and at a defined distance from the first achromatic doublet. The defined distance can be dependent on a first focal length of the first achromatic doublet, a second focal length of the second achromatic doublet and a distance between the first achromatic doublet and the second achromatic doublet.

In some implementations, a virtual thin lens equivalent to a combination of the first achromatic doublet positioned at the second position and the second achromatic doublet positioned at the third position can have an effective focal length (f_{eff}) defined in terms of the first focal length of the first achromatic doublet, the second focal length of the second achromatic doublet and the distance between the first achromatic doublet and the second achromatic doublet. The virtual thin lens can be located at a fourth position defined according to second position and the third position. The slot can be located at a distance equal to a value of a multiplication of an effective focal length with a sum of a constant and a tolerance factor of a distance between the slot and the virtual thin lens. The tolerance factor can be less than or equal to 0.02. The tolerance factor can be less than or equal to 0.01. The housing can include any type and form of an enclosure to contain and support the first structure that can secure the first achromatic doublet at the second position within the housing. The housing can include a second structure that can secure the second achromatic doublet at the third position within the housing. The light source can includes a white light emitting diode (LED). A distance between the slot and the light source can be less than or equal to 0.25 inch (e.g., 6.35 millimeters).

In some implementations, the first achromatic doublet and the second achromatic doublet are arranged such that a curved side of the first achromatic doublet is facing a curved side of the second achromatic doublet (e.g., crown to crown arrangement). Each of the first achromatic doublet and the second achromatic doublet can have a focal length equal to between 28 and 35 mm (e.g., between 1.10 and 1.38 inches). A kickstand element can adjust a pitch angle of the projector. The kickstand element can be made of rubber.

In some implementations, the slide can include a first transparent component, a second transparent component, and a transparent film. The transparent film can be placed between the first and second transparent components. The graphical image can be generated on a surface of the transparent film.

In some implementations, at least one of the first transparent component or the second transparent component can be configured such that when the transparent film is placed between the first transparent component and the second transparent component, the surface on which the graphical image is generated can be centered with respect to a width of the slide. The transparent film can be made of acetate. The graphical image can be generated on the transparent film using masking.

According to at least one aspect, a method can include providing, via a light source at a first position within a housing, a light beam. The method can include positioning a first achromatic doublet at a second position within the housing. The method can include positioning a second achromatic doublet at a third position within the housing. The second position can be between the first position and the third position. The method can include receiving, via a slot within the housing, a slide that includes a graphical image. The slot located between the first position and the second position and at a defined distance from the first achromatic doublet. The defined distance can be dependent on a first focal length of the first achromatic doublet, a second focal length of the second achromatic doublet and a distance between the first achromatic doublet and the second achromatic doublet. The method can include forming, by a combination of the first achromatic doublet positioned at the second position and the second achromatic doublet positioned at the third position, a virtual thin lens to produce an effective focal length (f_{eff}) defined in terms of the first focal length of the first achromatic doublet, the second focal length of the second achromatic doublet and the distance between the first achromatic doublet and the second achromatic doublet. The virtual thin lens can be located at a fourth position defined according to second position and the third position.

In some implementations, the method can include the slot located at a distance equal to a value of a multiplication of an effective focal length with a sum of a constant and a tolerance factor of a distance between the slot and the virtual thin lens. The tolerance factor can be less than or equal to 0.02. The tolerance factor can be less than or equal to 0.01. The light source can includes a white light emitting diode (LED). A distance between the slot and the light source can be less than or equal to 0.25 inch (e.g., 6.35 millimeters). Each of the first achromatic doublet and the second achromatic doublet can be arranged such that a curved side of the first achromatic doublet is facing a curved side of the second achromatic doublet (e.g., crown to crown arrangement). The distance between the two curved sides of the achromatic doublets can be less than 0.1 millimeter, less than 0.5 millimeter or less than 1 millimeter.

### BRIEF DESCRIPTION OF THE DRAWINGS

Non-limiting embodiments of the present disclosure are described by way of example concerning the accompanying figures, which are schematic and are not intended to be drawn to scale. Unless indicated as representing the background art, the figures represent aspects of the disclosure.

FIGS. 1A and 1B illustrate a diagram of projection system and an optical path of the projection system, according to an example embodiment of the current disclosure.

FIG. 2 illustrates a perspective views of a handheld projector, according to an example embodiment of the current disclosure.

FIG. 3 illustrates exploded views of the projector of FIG. 2, according to an example embodiment of the current disclosure.

FIG. 4 shows a cross-sectional view of the projector of FIG. 2, according to an example embodiment of the current disclosure.

FIGS. 5A and 5B show a front view and a rear view of the projector of FIG. 2, according to an example embodiment of the current disclosure.

FIGS. 6A and 6B show a top view and a bottom view of the projector of FIG. 2, according to an example embodiment of the current disclosure.

FIG. 7 shows an exploded view of a slide assembly, according to an example embodiment of the current disclosure.

FIG. 8 depicts a side view and a cross-sectional view of the slide assembly of FIG. 7, according to an example embodiment of the current disclosure.

FIGS. 9A and 9B show a front view and a rear view of the slide assembly, according to an example embodiment of the current disclosure.

FIG. 10 shows another cross-sectional view of the slide assembly, according to an example embodiment of the current disclosure.

FIG. 11 depicts an example of a slide that can be used by the projector of FIGS. 1-7.

FIG. 12 illustrates a flow diagram of an example method for projecting images, in accordance with some embodiments of the present disclosure.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting to the subject matter presented.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

When projecting images onto planar surfaces, image quality, such as sharpness and focus, tends to deteriorate as the distance between the projector and the surface increases. This issue is particularly challenging for small and compact projectors, where image aberrations become more pronounced over longer distances. As the planar projection surfaces move further from the projector, the projected images in the far field suffer from increased aberrations, resulting in deteriorated image quality. Consequently, maintaining high-quality, sharp images over a range of distances, including the far field, is a significant challenge for compact projectors.

The technical solutions of this disclosure overcomes these challenges by configuring a pair of achromatic doublet lenses at specific distances from each other and from the plane where the image slide is located. Each of the two achromatic doublets are positioned at particular locations within the housing with set distances apart, creating a virtual thin lens (e.g., thin lens equivalent) having an effective focal length that is defined by the focal lengths of the achromatic doublets and the distance between them. By further configuring the location of a slide carrying an image to be projected at a set distance apart from this effective focal length, the projector setup can produce sharp images over a wide range of projection distances with minimal adjustments and within a compact product form factor.

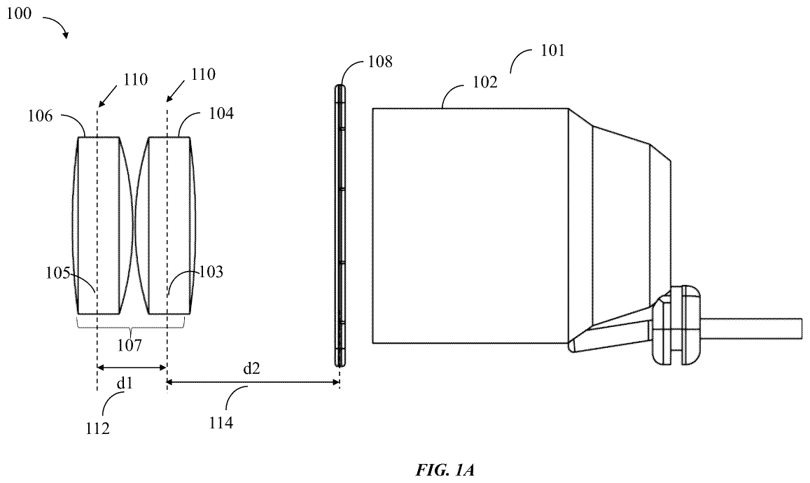

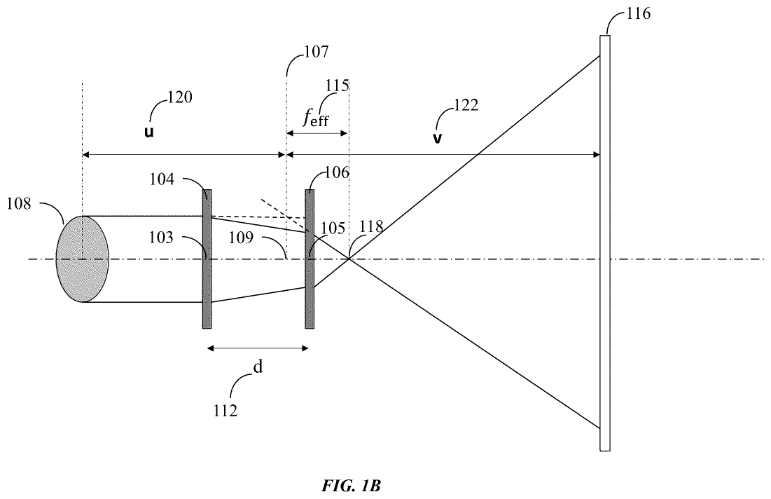

Referring now to FIG. 1A, illustrated is a diagram of an example projection system 100, such as a hand-held compact projection system for wide-range (e.g., near field and far field) projection. The system 100 can include a light source 102, a first achromatic doublet 104, a second achromatic doublet 106, and a slide 108. The light source 102 can be positioned within a housing of the projection system 100 and can provide a light beam that propagates through the optical components of the projection system 100. While FIG. 1A illustrates an example of only two achromatic doublets 104 and 106, it is understood that in some implementations, the system can include three or more achromatic doublets or other lenses arranged or organized at set distances from each other to form a virtual thin lens equivalent. It is also understood that distances between the lenses can be adjusted or fine tuned (e.g., using threaded or other adjustment components) to allow for movement of these optical components (e.g., achromatic lenses 104 and 106) closer and further apart from each other to change their lens properties (e.g., effective focal length).

The housing of the projection system 100 can include any type and form of an enclosure designed to contain and support the optical and structural components of the projection system 100. The housing can be configured to secure the light source 102, the first achromatic doublet 104, the second achromatic doublet 106, and the slot for the slide 108. It can also provide structural stability, alignment, and protection for these components during operation. For example, the housing can be made of materials such as plastic, metal, or composite polymers, selected based on durability, weight, and thermal management requirements. In some implementations, the housing can include additional features, such as venting or heat sinks to dissipate heat generated by the light source 102, or textured surfaces to enhance grip and portability. In some implementations, the housing can include modular components that allow for easy disassembly and reassembly. For example, the housing can include detachable panels or covers that provide access to the internal components (e.g., for maintenance or replacement).

The light beam can include any directed stream of electromagnetic radiation, such as a directional beam or a stream of light within a visible spectrum. The light beam can propagate in a straight, substantially parallel (e.g., parallel within 1-5%), including a slightly divergent or a focused path. The light beam can originate from various sources, such as light-emitting diodes (LEDs), lasers, or halogen lamps. For example, in some implementations, the light beam can include white light emitted from an LED, which can be collimated and directed through optical components to illuminate a slide. In other embodiments, the light beam can include light from a laser source. The nature and characteristics of the light beam can be varied based on the requirements of the projection system 100.

The light beam emitted by the light source 102 can be propagated through the transparent or semi-transparent slide 108 that includes an image to be projected. The light output from the slide 108 (e.g., modified by the slide 108 to represent the image to be projected) can then be manipulated by the first achromatic doublet 104 and the second achromatic doublet 106, so as to be projected outward (e.g., past the second achromatic doublet 106) toward a planar surface onto which the image from the slide 108 is to be projected. A virtual thin lens 107 can be formed by a combination of the first achromatic doublet 104 and the second achromatic doublet 106, to produce an effective focal length (f_{eff}) 115.

The light source 102 can include any source for emitting light for projecting images from the slide 108. The light source 102 can include a white or a colored (e.g., red, green or blue) light-emitting diode (LED) of high-lumen output. For instance, the light source 102 can have a white LED of more than 100, 200, 500 or 1000 lumens of white light. The light source 102 can have any other non-LED devices for emitting light, such as organic light emitting diodes (OLEDs), high-intensity discharge (HID) light sources, fluorescent lamps, Xenon light source or other similar devices capable of emitting a planar or a focused beam of light suitable for image projection. The light source 102 can include other illumination devices such as laser diodes or halogen lamps, depending on application requirements and design preferences. The position of the light source 102 relative to the other components within the projection system 100 can be optimized to ensure uniform illumination of a graphical image located on the slide 108. The light source 102 can placed in the first position 101 of the projection system 100.

The first position 101 can be a location within the housing of the projection system 100 where the light source 102 is secured. The first position 101 can be aligned with respect to the optical axis 110 to ensure that the light beam propagates through the optical components, including the first achromatic doublet 104, the slide 108, and the second achromatic doublet 106. The first position 101 can be configured to maintain alignment of the light source 102 within the projection system.

The placement of the first position 101 can be determined based on the design of the housing and the spatial relationships between the optical components. For example, the first position 101 can be located at a distance that ensures uniform illumination of the slide 108, allowing the graphical image to be projected with minimal distortion. The first position 101 can be changed depending on various types of light sources 102.

An achromatic doublet can include a pair of lenses made from materials with differing dispersion properties, such as crown glass and flint glass, bonded together to reduce chromatic aberration. An achromatic doublet lens can be an optical lens composed of two lenses made from different types of glass, designed to reduce chromatic aberration by bringing two wavelengths of light into focus at the same point. An achromatic doublet can focus light of different wavelengths, such as red and blue, at nearly the same point, resulting in improved image clarity and reduced color fringing. The lenses can be utilized in optical systems where high precision and minimal distortion are desired, such as projectors, cameras, and microscopes. The focal length of the achromatic doublet can be a design parameter that determines its placement and function within an optical system (e.g., system 100).

In some embodiments, the first achromatic doublet 104 can be positioned at a location within the projection system 100 and can serve as the initial optical element in the system 100. The first achromatic doublet 104 can correct chromatic aberrations and focus the light beam. The first achromatic doublet 104 can placed in a second position 103 of the projection system 100. A first focal length of the first achromatic doublet 104 can determine its relationship with other components, such as the slot for the slide 108 and the second achromatic doublet 106. The second achromatic doublet 106 can refine the light beam by correcting residual aberrations and enhancing image clarity. The second achromatic doublet 106 can placed in a third position 105 of the projection system 100. The second position 103 can be between the first position 101 and the third position 105.

The second position 103 can refer to a location within the projection system 100 where the first achromatic doublet 104 is positioned/secured. The second position 103 can be situated along the optical axis 110. The second position 103 can be between the first position 101 (where the light source 102 is located) and the third position 105 (where the second achromatic doublet 106 is located). The second position 103 can be configured to ensure that the light beam emitted from the light source 102 passes through the first achromatic doublet 104, which serves to correct chromatic aberrations and focus the beam effectively.

The placement of the second position 103 can be determined based on the focal length of the first achromatic doublet 104 and its relationship with other components, such as the slot for the slide 108 and the second achromatic doublet 106. The distance between the first position 101 and the second position 103 can be optimized/varied to ensure that the light beam is aligned and focused as it interacts with the graphical image on the slide 108. The alignment of the second position 103 within the housing of the projection system 100 can contribute to the overall precision and performance of the optical system.

The third position 105 can include any location within the projection system 100 where the second achromatic doublet 106 is positioned or secured. The third position 105 can be situated along the optical axis 110, following the second position 103, and configured to allow refined light beam to propagate toward a projection surface. The third position 105 can ensure proper alignment of the second achromatic doublet 106 relative to other components, such as the first achromatic doublet 104 and the slot for the slide 108, enhancing the clarity and quality of the projected image. For example, the third position 105 can be placed at a distance determined by the focal lengths of the first achromatic doublet 104 and the second achromatic doublet 106. In some implementations, the third position 105 can include mounting features, such as brackets or grooves, within the housing to securely hold the second achromatic doublet 106 in alignment.

In some implementations, the first achromatic doublet 104 and the second achromatic doublet 106 can each be an arrangement of lenses, such that a curved side of the first achromatic doublet is facing a curved side of the second achromatic doublet (e.g., crown to crown arrangement). The first achromatic doublet 104 and the second achromatic doublet 106 can each include a pair of cemented doublets, which can display a large field of view and minimal distortion. Coatings can be applied to the first achromatic doublet 104 and the second achromatic doublet 106 lens surfaces to enhance contrast.

In some embodiments, the first achromatic doublet 104 and the second achromatic doublet 106 can each include an optical axis 110. The optical axis 110 can serve as a reference for the placement and orientation of the achromatic doublet 104 and the second achromatic doublet 106 within the system 100. By maintaining alignment along the optical axis 110, the first achromatic doublet 104 can reduce chromatic aberration and focus the light beam for image projection. The optical axis 110 of the second achromatic doublet 106 can be positioned at a distance d1 112 from the optical axis 110 of the first achromatic doublet 104.

The slide 108 can include one or more components configured to hold and display a graphical image for projection. The slide 108 can include a first transparent component, a second transparent component, and a transparent film placed between the first and second transparent components. The graphical image to be projected can be generated on a surface of the transparent film, which can be aligned between the first and second transparent components. The transparent components can provide structural support and protection for the transparent film, ensuring that the graphical image remains undistorted during projection. The slide 108 can include functional layers or coatings. For example, the transparent film can include anti-scratch coatings or UV-resistant layers (e.g., to improve durability). The slide 108 can include multi-layered transparent films for projecting dynamic or multi-colored images. For example, a three-layer slide can incorporate red, green, and blue graphical elements, enabling color mixing for full-spectrum projections. The placement of the slide 108 within the projection system 100 can be designed to optimize the image quality by maintaining proper alignment with the optical elements.

The first and second transparent components can be made of materials such as glass, acrylic, or polycarbonate, selected for their optical clarity and durability. The transparent film can be made of materials such as acetate or polyester, which are thin, flexible, and capable of retaining high-quality graphical images. The graphical image on the transparent film can be generated using techniques such as masking, printing (e.g., photoprinting, ink jet printing), or laser etching. In some implementations, the graphical image can be generated on the acetate and/or the transparent film using a photoprinter or ink jet printer. In some implementations, the transparent components can include anti-reflective coatings or surface treatments to reduce glare and improve image contrast during projection. The slide 108 can be designed for reusability or as a replaceable component, offering flexibility for various use cases, such as educational tools, portable projectors, or custom image displays.

The slide 108 can include a graphical image to be projected and can be placed in a slot located within the system 100. The slot or slide 108 (e.g., the location at which the slot receives the slide) can be positioned at a distance d2 114 from the optical axis 110 of the first achromatic doublet 104. The distances d1 112 and d2 114 can represent spatial parameters in the system 100. The distance d1 112 can define the separation between the first achromatic doublet 104 and the second achromatic doublet 106, while d2 114 can define the distance between the slot containing the slide 108 and the first achromatic doublet 104. In some embodiments, a distance between the slot or slide 108 and the light source 102 can be less than or equal to 0.25 inch. In another embodiment, the distance between the slot or slide 108 and the light source 102 can be greater than or equal to 0.25 inch.

The distances d1 112 and d2 114 can be calibrated to align the optical components and ensure proper light focusing and image clarity. The distances d1 112 and d2 114 can depend on the focal lengths of the achromatic doublets. The distance d2 114 can depend on the first focal length of the first achromatic doublet 104, a second focal length of the second achromatic doublet 106, and the distance d1 112 separating the first achromatic doublet 104 from the second achromatic doublet 106. In some implementation, the first focal length of the first achromatic doublet 104 and the second focal length of the second achromatic doublet 106 can each have a focal length equal to between 28 to 35 mm (e.g., 32 mm).

The focal lengths of the achromatic doublets determine how light is bent, focused, and manipulated as it passes through each lens. The first achromatic doublet 104 can focus the incoming light from the slide and can determine where the light converges. The focal length of the first achromatic doublet 104 can affect the location of a focal plane relative to the slide 108 and, consequently, the distance d2. The second achromatic doublet 106 can refine and further focus the light after it passes through the first achromatic doublet 104. The second achromatic doublet 106 focal length can impact the overall optical behavior of the system 100, influencing the effective focal length (f_{eff}) 115 of the combined optical system, which in turn can affects the placement of the slide 108 at d2.

In some embodiments, the projection system 100 can include a virtual thin lens 107 formed by the combination of the first achromatic doublet 104 and the second achromatic doublet 106. The virtual thin lens 107 can have an effective focal length (f_{eff}) 115 that is defined based on the first focal length of the first achromatic doublet 104, the second focal length of the second achromatic doublet 106, and the distance d1 112 between the first achromatic doublet 104 and the second achromatic doublet 106.

The effective focal length (f_{eff}) 115 of the virtual thin lens can represent the combined optical behavior of the two achromatic doublets 104 and 106, enabling the system 100 to project a graphical image with minimal aberrations and optimized clarity. The virtual thin lens 107 can be located at a fourth position 109, which can be determined according to the spatial arrangement of the second position 103 (where the first achromatic doublet 104 is located) and the third position 105 (where the second achromatic doublet 106 is located).

FIG. 1B illustrates the optical path of an example compact projection system, in accordance with one or more implementations. The virtual thin lens 107 can have a focal point 118. The virtual thin lens 107 can be positioned at the fourth point 109. The distance between the focal point 118 and the virtual thin lens 107 can be the effective focal length f_{eff} 115. The virtual thin lens 107 can have the effective focal length f_{eff} 115 of the projection system. The effective focal length f_{eff} 115 can be defined in terms of the first focal length f₁ of the first achromatic doublet 104, the second focal length f₂ of the second achromatic doublet 106, and the distance d (e.g., d1 112) between the first achromatic doublet 104 and the second achromatic doublet 106. The effective focal length f_{eff} 115 can be adjusted or optimized for use cases, such as short-throw projections for confined spaces or long-throw projections for large surfaces. The effective focal length of an optical system can be calculated using the formula:

$${f}_{eff} = \frac{{f}_{1} \cdot {f}_{2}}{{f}_{1} + {f}_{2} - d}$$

The distance between the slide 108 (e.g., graphical image on the slide 108) and the virtual thin lens 107 (i.e., fourth point 109) can be labeled as u 120. A projected image 116 can correspond to the graphical image on the slide 108. The distance between the projected image 116 and the virtual thin lens 107 (i.e., fourth point 109) can be labeled as v 122. A lens equation can be presented, in terms of the effective focal length, as follows:

$$\frac{1}{{f}_{eff}} = \frac{1}{u} + \frac{1}{v}$$

For example, the effective focal length of the two achromatic doublets 104 and 106 can be based on, or determined using, a reciprocal of the sum of the reciprocals of the object distance (u) and the image distance (v). The object distance u 120 between the slide 108 and the virtual thin lens 107 can be represented in terms of a tolerance factor (e.g., a small offset) ε as follows:

$$u = ( 1 + ε ) {f}_{eff}$$

The tolerance factor can account for deviations or adjustments in the projection system, such as alignment, positioning errors, or fine-tuning. The term (1+ε) in the equation for the distance u 120 can include an additional small adjustment ε that can allow the slide 108 position relative to have the effective focal length f_{eff} 115 to accommodate tolerances or design requirements.

In some embodiments, the tolerance factor (ε) can vary based on the design requirements of the projection system 100. For example, in high-precision applications, the tolerance factor can be minimized to values such as 0.001 or lower to achieve sharp and detailed projections. In portable or flexible applications of the projection system 100, the tolerance factor can be adjusted to accommodate alignment errors or variations in the positioning of the slide 108. For example, a projection system 100 designed for outdoor advertising can use a larger tolerance factor to handle environmental factors like vibrations or uneven surfaces, while still delivering a consistent projection.

The lens equation can be expressed as follows:

$$\frac{1}{{f}_{eff}} = \frac{1}{( 1 + ε ) {f}_{eff}} + \frac{1}{v}$$

The distance v 122 between the projected image 116 and the virtual thin lens 107 can be calculated based on the lens equation:

$$v = \frac{1 + ε}{ε} {f}_{eff}$$

A magnification (M) of the graphical image on the slide 108 into the projected image 116 can be calculated using the formula:

$$M = \frac{v}{u} + \frac{\frac{1 + ε}{ε} {f}_{eff}}{( 1 + ε ) {f}_{eff}} = \frac{1}{ε}$$

The tolerance factor & in the magnification formula can demonstrate how the projection system parameters influence the size of the projected image. A rate of distortion in the projection system can be minimized or eliminated by a corresponding rate of growth of the magnified image. As magnification increases, any potential distortion can be compensated for or offset, thereby maintaining the clarity of the projected image. For example, when ε=0.01, then M=100 meaning the projected image size is 100 times larger than the original slide image. When ε=0.001, then M=1000, meaning the projected image is 1000 times larger than the original. When ε is small, such as 0.001, the projection system can achieve a large magnification which can be used for projecting highly detailed images over large surfaces. In some embodiments, the tolerance factor ε can be less than or equal to 0.02 (e.g., less than or equal to 0.01, less than or equal to 0.005, etc.).

The tolerance factor can be varied (e.g., tuned or adjusted) based on the application or preference. The system can include, for example, an adjustment threaded component for changing, adjusting or moving a distance 112 (e.g., distance between the two achromatic doublets 104 and 106) to adjust the projection distance or projection optimization for a particular distance from the projector (e.g., projection 10 feet, 50 feet or 100 feet away from the projector output). By changing such a threaded component, the distance 112 can be changed to impact or adjust the combined effective lens of the two (e.g., multiple) achromatic lenses (e.g., affect the f_{eff}) to adjust or focus the image for a projection at a particular projection plane at a desired distance or range from the projector. In some instances, a threaded component can be configured to adjust the distance between slot for the slide 108 and any combination of the first or the second achromatic lens (e.g., distance between the slide 108 and the lens 104, distance between slide 108 and lens 106, distance between slide 108 and the lenses 104 and 106 as a block, or distance between all three of the slide 108 and the two lenses 104 and 106). For example, in educational or scientific presentations, a larger magnification (e.g., M=1000) can be achieved by minimizing the tolerance factor to 0.001, allowing for visualization of small or intricate (e.g., detailed) images in a larger setting. For smaller projections, a larger tolerance factor (e.g., ε=0.01) can balance magnification with system simplicity. In some embodiments, anti-reflective coatings on the lenses can reduce stray light and enhance image contrast (e.g., in environments with high ambient light).

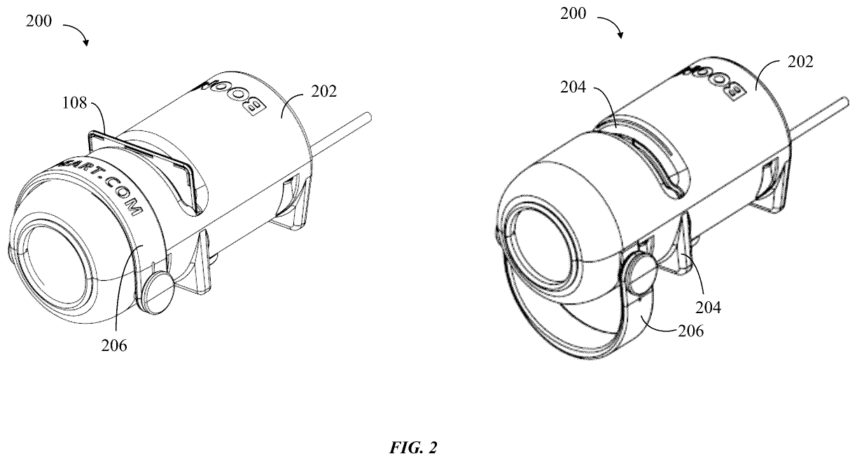

Referring now to FIG. 2, illustrated are perspective views of a handheld projector 200, in accordance with one or more implementations. The handheld projector 200 can be implemented using any one or more of the components and devices detailed herein in conjunction with FIG. 1. The handheld projector 200 can include a housing 202, a slot 204 configured to receive a slide (e.g., the slide 108), and a kickstand element 206. The housing 202 can enclose internal components such as the light source 102, the first achromatic doublet 104, and the second achromatic doublet 106, which work together to project graphical images.

The housing 202 can provide structural support and enclose optical and electrical components of the handheld projector 200. The housing 202 can contain the light source 102, the first achromatic doublet 104, and the second achromatic doublet 106, as detailed in FIG. 1. These components can be securely positioned within the housing 202 to maintain alignment along the optical axis 110. For example, the housing 202 can secure the first achromatic doublet 104 at the second position 103, and can secure the second achromatic doublet 106 at the third position 105.

The housing 202 can be fabricated from materials such as plastic, aluminum, or composite polymers, chosen for their durability, lightweight properties, and thermal management capabilities. In some embodiments, the housing 202 can include ergonomic features, such as textured surfaces or contoured grips, to enhance portability and ease of handling. The housing 202 can include vents or heat sinks to dissipate heat generated by the light source 102 during operation.

The slot 204 can be positioned within the housing 202 and configured to receive a slide, such as the slide 108 described in FIG. 1. The slot 204 can be aligned with the light source 102, the first achromatic doublet 104, and the second achromatic doublet 106 to ensure that the graphical image on the slide is illuminated and focused correctly for projection. The slot 204 can be positioned between the light source 102 and the virtual thin lens 107 (e.g., the first achromatic doublet 104 and the second achromatic doublet 106). The slot 204 can allows for modularity, enabling users to easily replace or customize the slide 108 to project different images. In some embodiments, the slot 204 can include locking mechanisms or spring-loaded elements to secure the slide in place and ensure precise alignment.

The kickstand element 206 can be attached to the housing 202 and configured to adjust the pitch angle of the handheld projector 200. The kickstand element 206 can be constructed from rubber or a similar material. The kickstand element 206 can provide a stable base, preventing the handheld projector 200 from slipping during operation. The kickstand element 206 can be made of rubber or other types of materials. For example, rubber-like materials, such as silicone or thermoplastic elastomers, can be used, providing flexibility, durability, and non-slip properties. In some implementations, the kickstand element 206 can include rigid materials like plastic or metal for enhanced structural support.

In some embodiments, the kickstand element 206 can be foldable or telescoping, allowing users to adjust the handheld projector 200 angle across a range of positions. For example, the kickstand element 206 can enable projection onto walls, ceilings, or angled surfaces, increasing the versatility of the handheld projector 200. In other implementations, the kickstand element 206 can include additional features, such as magnetic attachments for mounting the handheld projector 200 onto metal surfaces or built-in leveling mechanisms to ensure stability on uneven surfaces. The kickstand element 206 can include a bubble level to ensure the handheld projector 200 is aligned with the projection surface. In another implementation, the kickstand element 206 can be motorized, allowing users to adjust the pitch angle remotely. The kickstand element 206 can also include interchangeable feet, such as rubber pads for non-slip surfaces or magnetic bases for mounting onto metal objects.

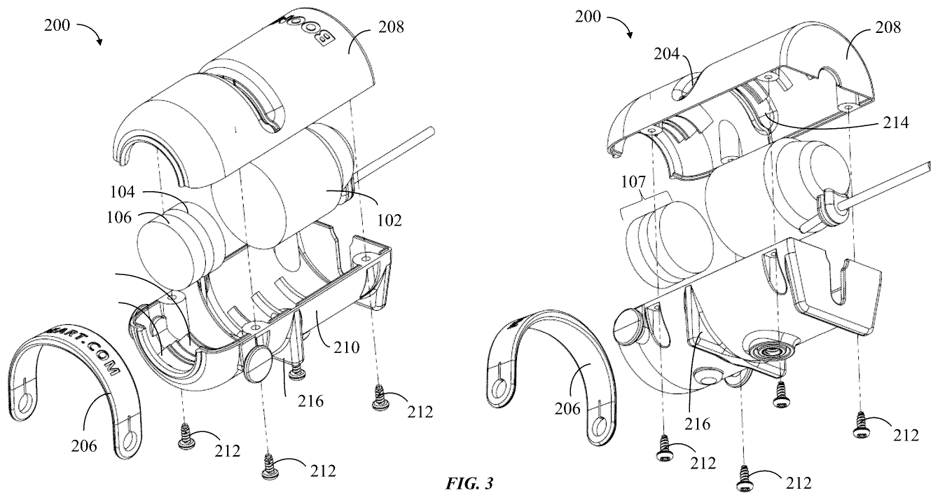

Referring now to FIG. 3, illustrated are exploded views of the handheld projector 200 of FIG. 2, in accordance with one or more implementations. The exploded views in FIG. 3 provide a breakdown of the components and their assembly within the handheld projector 200. The handheld projector 200 includes the housing 202 with a first structure 208 and a second structure 210, the slot 204 configured to receive a slide (e.g., slide 108), a kickstand element 206, mounting structure 216, and various securing elements 212. The light source 102, the first achromatic doublet 104, and the second achromatic doublet 106, previously detailed in FIG. 1, are also visible within the exploded views.

The first structure 208 of the housing 202 can form the upper part of the handheld projector 200. It can be designed to enclose and protect the optical components, including the light source 102, the first achromatic doublet 104, and the second achromatic doublet 106. The first structure 208 can also include openings or access points, such as the slot 204 for receiving a slide, enabling the projector to function seamlessly. The first structure 208 can include an element 214 that can include grooves or tracks to guide the slide during insertion into the slot 204. In some implementations, the element 214 can ensure alignment of the light source 102 within the handheld projector 200. In some implementations, the first structure 208 can be fabricated from lightweight yet durable materials like plastic, ensuring portability while protecting internal components from damage.

The second structure 210 of the housing 202 can form the lower part of the handheld projector 200 and can support the internal components (e.g., the light source 102, the first achromatic doublet 104, and the second achromatic doublet 106). The second structure 210 can serve as a mounting base for the kickstand element 206, allowing users to adjust the pitch angle of the projector. Additionally, the second structure 210 can include features such as grooves or brackets to securely hold the light source 102 and the achromatic doublets 104 and 106 in their positions. In certain embodiments, the second structure 210 can include rubberized pads or textured surfaces to prevent slipping during use.

In some implementations, the second structure 210 can include the mounting structure 216. The mounting structure 216 can align and secures the slot 204 and/or the slide 108 within the housing 202. The mounting structure 216 can provide mechanical stability to the slot 204 and/or the slide 108. The mounting structure 216 can provide accurate positioning of the slide 108 relative to the light source 102 and the achromatic doublets 104 and 106. In one embodiment, mounting structure 216 can include slide guides or retention clips that hold the slide 108 securely within the slot 204. The guides can prevent movement of the slide during operation, ensuring alignment with the light source 102 and achromatic doublets 104 and 106. The mounting structure 216 can be part of the second structure 210 of the housing 202, forming part of the support framework for the slot 204.

The securing elements 212 can be screws, rivets, or similar fasteners that can join the first structure 208 to the second structure 210 (e.g., of the housing 202). For example, at least one securing element 212 (e.g., 1, 2, 3, 4, 5, 6 securing elements etc.) can be used to provide structural integrity and ensure the first structure 208 to the second structure 210 remain tightly connected. The securing element 212 can be made from materials such as stainless steel or high-strength plastic, depending on the design requirements. The securing element 212 can allow for disassembly, enabling users to access the internal components of the handheld projector 200 for maintenance or replacement.

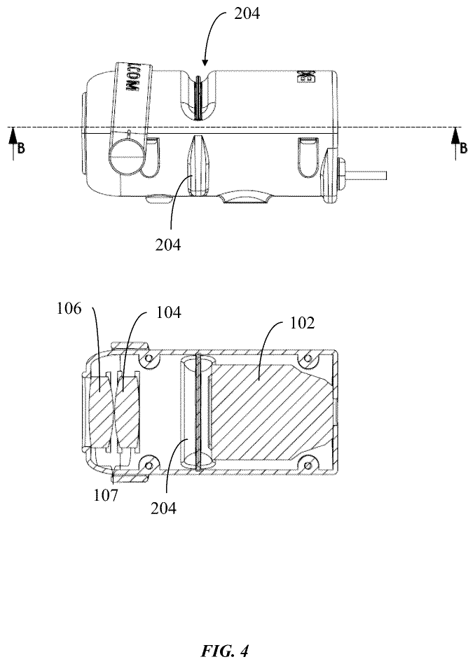

FIG. 4 illustrates cross-sectional views of the handheld projector 200 of FIG. 2, in accordance with one or more implementations. FIG. 4 highlights the internal arrangement of the handheld projector 200 components, including the light source 102, the first achromatic doublet 104, and the second achromatic doublet 106, aligned along the optical axis for precise projection. The slot 204, positioned within the housing 202, is configured to securely receive a slide 108 containing a graphical image.

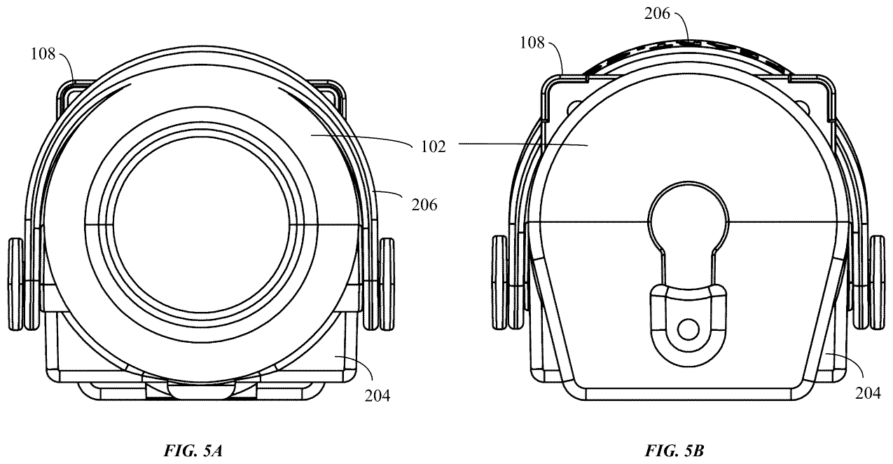

FIGS. 5A and 5B illustrate the front and rear views, respectively, of the handheld projector 200 of FIG. 2, in accordance with one or more implementations. FIG. 5A shows the front of the projector, highlighting the optical system, including the light source 102, and the position of the slot 204, where the slide 108 can be inserted for projection. The kickstand element 206 is also presented. FIG. 5B presents the rear view of the projector, showcasing the back of the housing and the slot 204. The ergonomic design of the housing ensures portability, while the alignment of components such as the kickstand element 206 presents the functional versatility of the handheld projector 200, allowing for projection at various angles and surfaces.

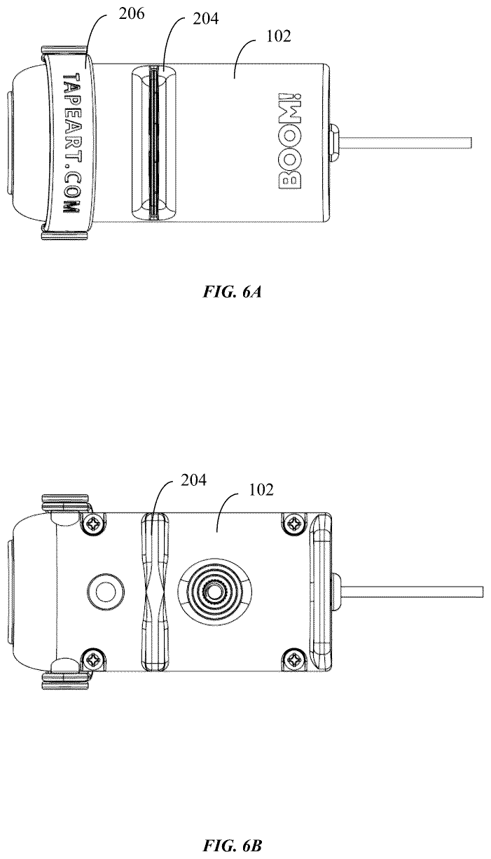

FIGS. 6A and 6B illustrate the top and bottom views of the handheld projector 200 of FIG. 2, in accordance with an example embodiment of the current disclosure. FIG. 6A highlights the placement of the slot 204 and the kickstand element 206 from a top perspective, showcasing the handheld projector 200 compact design. FIG. 6B provides a view of the bottom side of the housing 202.

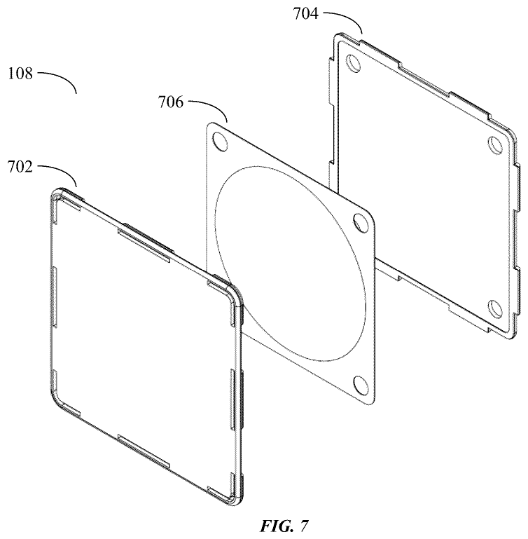

FIG. 7 shows an exploded view of a slide assembly (e.g., of slide 108), in accordance with one or more implementations. The slide assembly (e.g., slide 108) presented can include some or all the features of slide 108 presented in FIG. 1. The slide 108 can include a first transparent component 702, a second transparent component 704, and a transparent film 706. The transparent film 706 can be positioned between the first transparent component 702, and the second transparent component 704. The transparent film 706 can feature a graphical image to be projected. The graphical image can be generated on a surface of the transparent film 706. The transparent components 702 and 704 can provide structural support to the transparent film 706. The modular design of the slide assembly (e.g., slide 108) allows for reusability or replacement and can allow for a range of image projections.

In some implementations, at least one of the first transparent component 702 or the second transparent component 704 can be configured such that when the transparent film 706 is placed between the first transparent component 702 and the second transparent component 704, the surface on which the graphical image is generated can be centered with respect to a width of the slide 108. The graphical image can be generated on the transparent film 706 using masking, a where selective areas of the transparent film 706 are exposed or blocked to create the desired graphical image. Masking can include applying a mask (such as a stencil or photographic negative) to the transparent film 706 and exposing it to light or a chemical process, resulting in a high-contrast image. For example, masking can be implemented using photolithography, where the transparent film 706 is coated with a light-sensitive material and exposed to UV light through a patterned mask, creating intricate designs or detailed text. In another example, screen printing can be used to directly apply opaque or translucent inks onto the transparent film 706 through a fine mesh stencil. The surface (e.g., on the transparent film 706) on which the graphical image is generated can be centered with respect to a width of the slide 108.

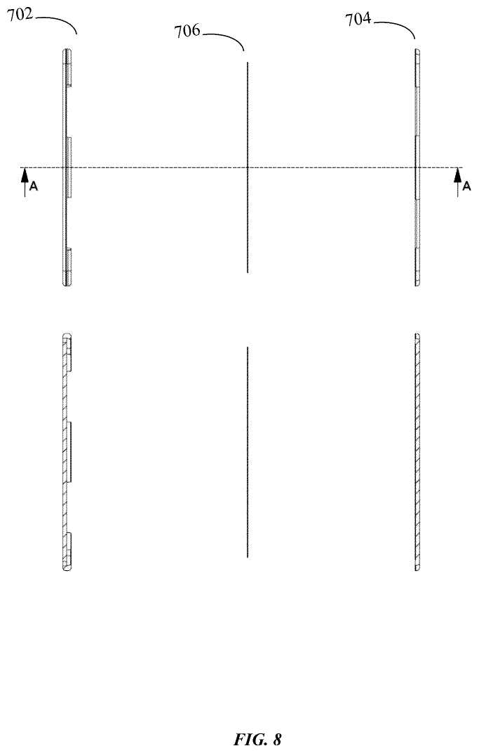

FIG. 8 depicts a side view and a cross-sectional view of the slide assembly, showing the alignment of its components, including the first transparent component 702, the second transparent component 704, and the transparent film 706 positioned between them. The first transparent component 702, the second transparent component 704, and the transparent film 706 can be stacked and secured together to create a slide assembly that maintains the graphical image in proper alignment for projection.

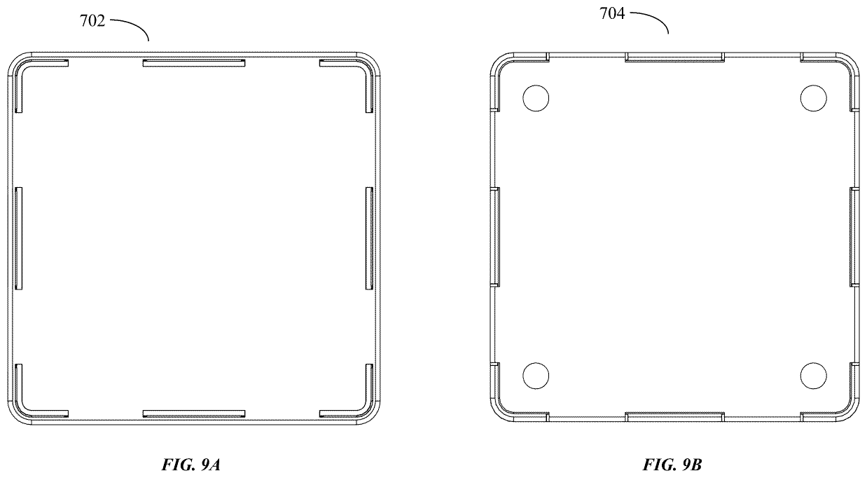

FIGS. 9A and 9B depicts front and rear views of the slide assembly, respectively, in accordance with one or more implementations. The first transparent component 702 and the second transparent component 704 can include features such as clips or notches for alignment and secure assembly.

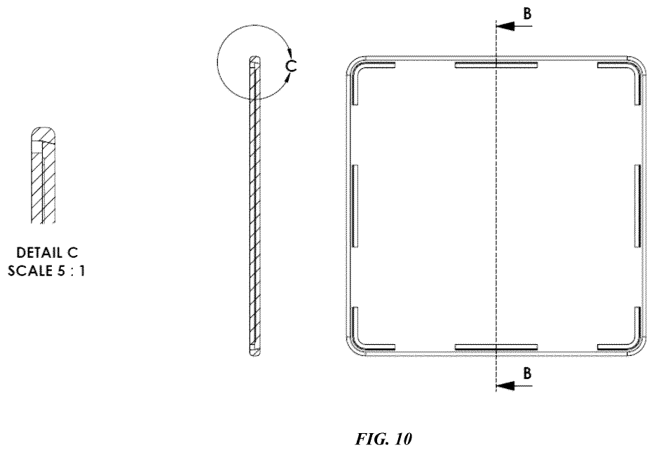

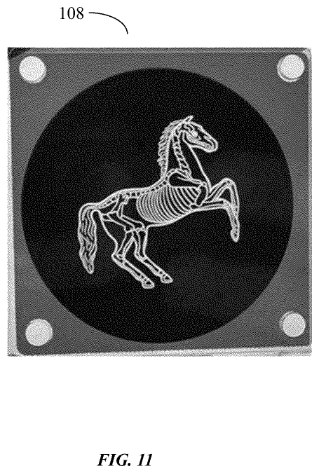

FIG. 10 offers an additional cross-sectional view, with detail C providing a magnified look at the edge profile of the slide assembly (e.g., slide 108).

FIG. 11 illustrates a slide (e.g., slide 108) used to project an image of a skeletal horse.

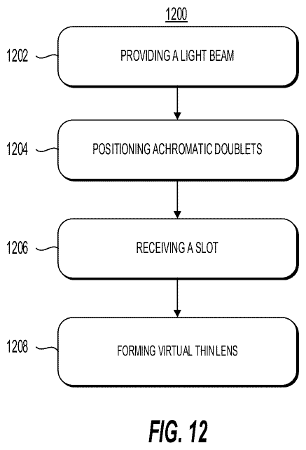

FIG. 12 illustrates a flow diagram of an example method projecting images. The method 1200 may be implemented using any one or more of the components and devices detailed herein in conjunction with FIGS. 1-11. In overview, the method 1200 may be performed by a light source 102, along with any number of its optical components, including for example: a first achromatic doublet 104, a second achromatic doublet 106, and a slide 108 in some embodiments. Additional, fewer, or different operations may be performed in the method 1200 depending on the embodiment. At least one aspect of the operations can be directed to a system, method and an apparatus.

With regards to (1202), and in some embodiments, a method can include providing a light beam that propagates (e.g., substantially perpendicularly) towards or through optical components (e.g., optical components of the projection system 100). The light beam can be provided via a light source (e.g., light source 102). The light source can be positioned at a first location or a first position within a housing or can be provided from an external source (e.g., outside of the housing) and directed to the optical components (e.g., achromatic lenses). In some implementations, the first position can be a position at which the externally generated light from the external light source is brought (e.g., via an optical waveguide or a fiber optic cable) into the enclosure and positioned towards the positions of the achromatic (e.g., and other) lenses. The light emitted by the light source can be propagated through the transparent or semi-transparent slide 108 that includes an image to be projected. The light source can include a white light emitting diode (LED).

In some embodiments, the light beam can be emitted from other types of light sources besides white LED. For example, the light source can include a colored LED (e.g., red, yellow, orange, green, or blue) or a combination of LEDs to provide tunable light outputs. The light source can also include non-LED devices, such as laser diodes, halogen lamps, or high-intensity discharge lamps, depending on application requirements for brightness and color fidelity. The light beam emitted from the light source can be collimated using collimators or reflectors. The light beam can propagate through slides with varying levels of transparency, such as frosted slides or slides with holographic images. The housing can be configured to include mechanisms for adjusting the position or intensity of the light source, enabling a user to control (e.g., externally via buttons, etc.) the brightness and focus of the light beam. The light beam can be directed towards two achromatic doublet lenses or any other number of achromatic doublet or other lenses that can be combined to provide or generate a desired equivalent thin lens of a particular focus.

With regards to (1204), the method can include providing or positioning a first achromatic doublet (e.g., first achromatic doublet 104) at a particular set position or location (e.g., a second position) within the housing. The method can include providing or positioning a second achromatic doublet (e.g., second achromatic doublet 106) at a third position (e.g., a third position) within the housing. The second position of the first achromatic doublet can be located between the first position (e.g., of the light source) and the third position (e.g., of the second doublet). The first achromatic doublet (e.g., first achromatic doublet 104) can serve as an initial optical element in the system 100. The first achromatic doublet (e.g., first achromatic doublet 104) can correct chromatic aberrations and focus the light beam. A first focal length of the first achromatic doublet can determine its relationship with other components, such as the slot for the slide 108 and the second achromatic doublet 106. The second achromatic doublet 106 can refine the light beam by correcting residual aberrations and enhancing image clarity. The second achromatic doublet 106 can placed in a third position 105 of the projection system 100. The second position 103 can be between the first position 101 and the third position 105.

In some implementations, the achromatic doublets can be composed or formed in the aggregate using multiple lenses, such as replaced with other lens types, including aspheric lenses, to further reduce aberrations and improve image clarity. The achromatic doublets (e.g., first achromatic doublet 104 and second achromatic doublet 106) can include materials with varying refractive indices, such as crown glass and flint glass, that can optimize light dispersion correction based on the spectral properties of the light beam. The achromatic doublets (e.g., first achromatic doublet 104 and second achromatic doublet 106) can include coatings or surface treatments that can reduce glare.

The positioning of the achromatic doublets (e.g., first achromatic doublet 104 and second achromatic doublet 106) can vary. For example, the second position 103 can be adjustable, allowing the first achromatic doublet to move closer to or farther from the light source (e.g., for fine-tuning focus). The third position 105 can include alignment brackets or adaptive mounts that can enable the second achromatic doublet 106 to be repositioned for different projection distances.

With regards to (1206), the method can include receiving, via a slot within the housing, a slide (e.g., slide 108) that includes a graphical image. A distance between the slot and the light source can be less than or equal to 0.25 inch. The light output from a slide 108 (e.g., modified by the slide 108 to represent the image to be projected) can be manipulated by the first achromatic doublet 104 and the second achromatic doublet 106, so as to be projected outward (e.g., past the second achromatic doublet 106) toward a planar surface onto which the image from the slide 108 is to be projected.

The method can include adjusting or providing for adjustment one or more adjustment components allowing for change of the distances (e.g., d 112) between the achromatic lenses to impact, fine tune, adjust or change the effective focal point of the equivalent thin lens formed by the two achromatic doublets. The adjustment components can be provided to allow for adjustment of the distance between the first or the second achromatic doublet and the slide or slot position or to allow distance adjustment(s) between two achromatic (e.g., or other) lenses in the group of lenses forming the equivalent effective thin lens.

In some implementations, the slot can include a locking mechanism to securely hold the slide 108 in place. The slot can prevent movement of the slide 108 during operation. The slot can receive slides 108 of different shapes and sizes, including rectangular and circular slides. The slot can include optical filters or polarizers to modify the light beam as it passes through the slide. For example, the slot can include a polarizing filter to reduce a glare. The slot can include a color filter to enhance image tones.

In some embodiments, the slot can be located between the first position and the second position and at a defined distance from the first achromatic doublet. The defined distance can be dependent on a first focal length of the first achromatic doublet, a second focal length of the second achromatic doublet and a distance between the first achromatic doublet and the second achromatic doublet.

With regards to (1208), the method can include forming, by a combination of the first achromatic doublet positioned at the second position and the second achromatic doublet positioned at the third position, a virtual thin lens. The virtual thin lens can produce an effective focal length (f_{eff}) defined in terms of the first focal length of the first achromatic doublet, the second focal length of the second achromatic doublet and the distance between the first achromatic doublet and the second achromatic doublet. The virtual thin lens can be located at a fourth position defined according to second position and the third position.

The slot can be located at a distance equal to a value of a multiplication of an effective focal length with a sum of a constant and a tolerance factor of a distance between the slot and the virtual thin lens. The constant can have a value of 1 and the tolerance factor can be less than or equal to 0.02 (e.g., less than or equal to 0.01).

In some embodiments, the virtual thin lens formed by the combination of the first and second achromatic doublets can have its properties adjusted. For example, the distance between the first achromatic doublet 104 and the second achromatic doublet 106 can be varied to modify the effective focal length (f_{eff}), enabling the projection system 100 to adapt to different projection distances or image sizes. The adjustment can be via mechanical actuators or automated alignment systems within the housing.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations, elements, or acts of the systems and methods herein referred to in the singular may also embrace implementations including a plurality of these elements; and any references in plural to any implementation, element, or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation or embodiment disclosed herein may be combined with any other implementation or embodiment, and references to “an implementation,” “some implementations,” “an alternate implementation,” “various implementation,” “one implementation,” “an embodiment,” “some embodiments,” “an alternate embodiment,” “various embodiments,” “one embodiment,” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description, or any claim are followed by reference signs, the reference signs have been included for the sole purpose of increasing the intelligibility of the drawings, detailed description, and claims. Accordingly, neither the reference signs nor their absence has any limiting effect on the scope of any claim elements.

The systems and methods described herein may be embodied in other specific forms without departing from their characteristics thereof. The systems and methods described herein may be applied to other environments. The foregoing implementations are illustrative, rather than limiting, of the described systems and methods. The scope of the systems and methods described herein may thus be indicated by the appended claims, rather than the foregoing description, and changes that come within the meaning and range of equivalency of the claims are embraced therein.

What is claimed is:

1. A projector comprising:
a housing;
a light source to provide a light beam, the light source positioned at a first position within the housing;
a first achromatic doublet positioned at a second position within the housing; and
a second achromatic doublet positioned at a third position within the housing, the second position between the first position and the third position,
wherein the housing includes a slot to receive a slide that includes a graphical image, the slot located between the first position and the second position and at a defined distance from the first achromatic doublet, the defined distance dependent on a first focal length of the first achromatic doublet, a second focal length of the second achromatic doublet and a distance between the first achromatic doublet and the second achromatic doublet.

2. The projector of claim 1, further comprising:
a virtual thin lens formed by a combination of the first achromatic doublet positioned at the second position and the second achromatic doublet positioned at the third position to produce an effective focal length (f_{eff}) defined in terms of the first focal length of the first achromatic doublet, the second focal length of the second achromatic doublet and the distance between the first achromatic doublet and the second achromatic doublet, wherein the virtual thin lens is located at a fourth position defined according to second position and the third position.

3. The projector of claim 2, wherein the slot is located at a distance equal to a value of a multiplication of an effective focal length with a sum of a constant and a tolerance factor of a distance between the slot and the virtual thin lens.

4. The projector of claim 3, wherein the constant has a value of 1 and the tolerance factor is less than or equal to 0.02.

5. The projector of claim 3, wherein the tolerance factor is less than or equal to 0.01.

6. The projector of claim 1, wherein the housing includes:
a first structure to secure the first achromatic doublet at the second position within the housing; and
a second structure to secure the second achromatic doublet at the third position within the housing.

7. The projector of claim 1, wherein the light source includes a white light emitting diode (LED) and a distance between the slot and the light source is less than or equal to 0.5 inch.

8. The projector of claim 1, the first achromatic doublet and the second achromatic doublet are arranged such that a curved side of the first achromatic doublet is facing a curved side of the second achromatic doublet.

9. The projector of claim 8, wherein a distance between the curved side of the first achromatic doublet and the curved side of the second achromatic doublet is less than 0.5 millimeters.

10. The projector of claim 1, wherein each of the first achromatic doublet and the second achromatic doublet has a focal length equal to between 28 and 35 mm.

11. The projector of claim 1, wherein the projector further comprises a kickstand element configured to adjust a pitch angle of the projector.

12. The projector of claim 1, wherein the projector further comprises the slide, the slide comprising:
a first transparent component;
a second transparent component; and
a transparent film placed between the first transparent component and the second transparent component, the graphical image generated on a surface of the transparent film.

13. The projector of claim 11, wherein at least one of the first transparent component or the second transparent component is configured such that when the transparent film is placed between the first transparent component and the second transparent component, the surface on which the graphical image is generated is centered along a width of the slide.

14. The projector of claim 11, wherein the transparent film is made of acetate.

15. The projector of claim 11, wherein the graphical image is generated on the transparent film using at least one of photoprinting or ink jet printing.

16. A method, comprising:
providing, via a light source at a first position within a housing, a light beam;
positioning a first achromatic doublet at a second position within the housing; and
positioning a second achromatic doublet at a third position within the housing, the second position between the first position and the third position,
receiving, via a slot within the housing, a slide that includes a graphical image, the slot located between the first position and the second position and at a defined distance from the first achromatic doublet, the defined distance dependent on a first focal length of the first achromatic doublet, a second focal length of the second achromatic doublet and a distance between the first achromatic doublet and the second achromatic doublet; and
forming, by a combination of the first achromatic doublet positioned at the second position and the second achromatic doublet positioned at the third position, a virtual thin lens to produce an effective focal length (f_{eff}) defined in terms of the first focal length of the first achromatic doublet, the second focal length of the second achromatic doublet and the distance between the first achromatic doublet and the second achromatic doublet, wherein the virtual thin lens is located at a fourth position defined according to second position and the third position.

17. The method of claim 16, wherein the slot is located at a distance equal to a value of a multiplication of an effective focal length with a sum of a constant and a tolerance factor of a distance between the slot and the virtual thin lens.

18. The method of claim 17, wherein the constant has a value of 1 and the tolerance factor is less than or equal to 0.02.

19. The method of claim 16, wherein the light source includes a white light emitting diode (LED) and a distance between the slot and the light source is less than or equal to 0.25 inch.

20. The method of claim 16, wherein the first achromatic doublet and the second achromatic doublet are arranged such that a curved side of the first achromatic doublet is facing a curved side of the second achromatic doublet and a distance between the curved side of the first achromatic doublet and the curved side of the second achromatic doublet is less than 0.5 millimeters.
